(19) United States
(12) Patent Application Publication
(10) Pub. No.: US 2012/0014461 A1
(43) Pub. Date: Jan. 19, 2012

(54) Phase adjustment method, data transmission device, and data transmission system

(75) Inventor: Takatsugu Sasaki, Kawasaki (JP)

(73) Assignee: FUJITSU LIMITED, Kawasaki (JP)

(21) Appl. No.: 13/200,371

(22) Filed: Sep. 23, 2011

Related U.S. Application Data
(63) Continuation of application No. PCT/JP2009/056368, filed on Mar. 27, 2009.

(51) Int. Cl. H04L 27/00

(52) U.S. Cl. 375/259; 375/295

(57) ABSTRACT

A method of adjusting a phase includes generating phase adjustment patterns corresponding to transmission circuits by performing a serial-to-parallel conversion on a fundamental phase adjustment pattern in a transmission side circuit; transmitting, by the transmission circuits, transmission signals including the phase adjustment patterns; generating phase adjustment patterns corresponding to receiving circuits corresponding to the transmission circuits by performing the serial-to-parallel conversion on the fundamental phase adjustment pattern in a receiving side circuit; receiving, by the receiving circuits, the transmission signals using a reception clock signal; comparing signal patterns included in the transmission signals with the phase adjustment patterns and output comparison results; and adjusting a phase of the reception clock signal based on the comparison results.

### CROSS-REFERENCE TO RELATED APPLICATIONS

This application is a U.S. continuation application filed under 35 USC 111(a) claiming benefit under 35 USC 120 and 365(c) of PCT application JP 2009/056368, filed on Mar. 27, 2009. The foregoing application is hereby incorporated herein by reference.

### FIELD

The embodiment discussed herein is related to a phase adjustment method, a data transmission device, and a data transmission system.

### BACKGROUND

There has been known a data transmission system including a transmission side circuit and a receiving side circuit. In the data transmission system, the transmission side circuit converts serial data into parallel data, generates a synchronization pattern, and inserts the synchronization pattern into the parallel data to generate synchronization pattern insertion data. The receiving side circuit extracts a reference clock based on one of the synchronization pattern insertion data having transmission delay differences from each other. Then, the receiving side circuit generates transfer data by transferring all data using the reference clock. Further, the receiving side circuit generates a pulse signal corresponding to the synchronization pattern, detects the establishment of the synchronization of the transfer data, and detects the transmission delay differences based on the pulse signal to perform a phase adjustment.
Patent Document 1: Japanese laid-open Patent Publication No. 2003-204318
Patent Document 2: Japanese laid-open Patent Publication No. 2008-182483

Plural phase adjustment patterns are used to adjust the phases of the clock signal that is used when plural receiving circuits receive data from plural transmission circuits. As the configuration of the phase adjustment patterns, it is requested that all data do not present the same theoretical value at the same time.

### SUMMARY

According to an aspect of the present invention, the transmission side circuit generates plural phase adjustment patterns by performing a serial-to-parallel conversion on a fundamental phase adjustment pattern, and transmits the generated the plural phase adjustment patterns. The receiving side circuit also generates plural phase adjustment patterns by performing a similar serial-to-parallel conversion, acquires data based on signals received from the transmission side circuit using a reception clock signal, and compares the acquired data with the generated plural phase adjustment patterns. Based on a result of the comparison, the receiving side circuit adjusts the phases of the reception clock signal.

The fundamental phase adjustment pattern includes plural bits and has a predetermined cycle. The number of bits of the predetermined cycle of the fundamental phase adjustment pattern and the number of the plural phase adjustment patterns obtained by performing the serial-to-parallel conversion on a fundamental phase adjustment pattern are determined in a manner that the numbers are relatively prime to each other. The plural phase adjustment patterns has a feature that all of the plural phase adjustment patterns do not present the same theoretical value at the same time among the plural transmission circuits and the plural receiving circuits by allocating bits of the fundamental phase adjustment pattern among the plural transmission circuits and the plural receiving circuits, respectively, in accordance with a predetermined order by performing the serial-to-parallel conversion. The serial-to-parallel conversion is performed in a manner that the bit data of the fundamental phase adjustment pattern are sequentially allocated to the plural phase adjustment patterns in accordance with a predetermined order. The plural phase adjustment patterns are obtained by performing the serial-to-parallel conversion. Herein, the serial-to-parallel conversion refers to a conversion converting serial data into parallel data.

The object and advantages of the disclosure will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example block diagram illustrating a configuration of a transmission side circuit and a receiving side circuit included in a data transmission system according to an embodiment of the present invention;

FIG. 2 is an example block diagram illustrating an internal configuration of a transmission circuit in FIG. 1;

FIG. 3 is an example block diagram illustrating an internal configuration of a receiving circuit in FIG. 1;

FIG. 4 illustrates a reference example of a phase adjustment pattern generation method;

FIG. 5 illustrates an example phase adjustment pattern generation method according to an embodiment of the present invention;

FIG. 6 illustrates an example of generated phase adjustment patterns according to an embodiment of the present invention;

FIG. 7 is an example circuit diagram for generating the phase adjustment patterns according to an embodiment of the present invention;

FIG. 8 is an example flowchart of a phase adjustment operation performed in the receiving side circuit according to an embodiment of the present invention;

FIG. 9 is an example flowchart of a phase adjustment pattern generation operation performed in the transmission side circuit;

FIG. 10 an example time chart illustrating a flow of the phase adjustment operation in the data transmission system according to an embodiment of the present invention;

FIG. 11 is an example circuit diagram illustrating a preamble detection circuit in FIG. 3; and

FIG. 12 is an example circuit diagram illustrating an M-sequence generation circuit.

### DESCRIPTION OF EMBODIMENT

In the following, embodiments of the present invention are described.

An embodiment of the present invention relates to a data transmission system. More particularly, an embodiment of the present invention relates to a data transmission system where plural transmission circuits transmit plural transmission data in parallel to plural receiving circuits.

Further, in an embodiment of the present invention, in each of the plural receiving circuits, phase adjustment patterns are generated based on a method described below. Herein, the phase adjustment patterns are used to adjust the phases of a reception clock signal. The reception clock signal is used to extract (acquire) transmission data from transmission signals transmitting (including) the transmission data. In this method, a phase adjustment pattern generation circuit generates a fundamental phase adjustment pattern. A serial-to-parallel conversion circuit performs a serial-to-parallel conversion on the fundamental phase adjustment pattern. Herein, the “serial-to-parallel conversion” refers to a conversion that converts serial data into parallel data. As a result of the serial-to-parallel conversion, plural phase adjustment patterns are obtained. The plural phase adjustment patterns are used as the phase adjustment patterns for the corresponding transmission signals transmitted from the plural transmission circuits to the respective plural receiving circuits. Herein, “the phase adjustment patterns for the corresponding transmission signals” refers to the phase adjustment patterns corresponding to the signal lines through which the respective plural transmission signals are transmitted from the respective transmission circuits to the receiving circuits. Therefore, the phase adjustment patterns corresponding to the respective plural transmission signals may also be called the phase adjustment patterns corresponding to the signal lines or the phase adjustment patterns corresponding to the respective lanes. Herein, the term “lane” refers to a name to identify the plural signal lines that are used when transmission data are transmitted in parallel.

Further, in this embodiment, it is assumed that the fundamental phase adjustment pattern generated by the phase adjustment pattern generation circuit satisfies the following condition. Namely, the fundamental phase adjustment pattern is determined in a manner that the number of bits of the cycle of the fundamental phase adjustment pattern and the number of the phase adjustment patterns obtained by performing the serial-to-parallel conversion on the fundamental phase adjustment pattern are relatively prime to each other. By doing this, it may become possible to use the same phase adjustment pattern in each of the lanes to perform the phase adjustment. Namely, when the fundamental phase adjustment pattern satisfying the above condition is generated and the serial-to-parallel conversion is performed on the fundamental phase adjustment pattern to generate the phase adjustment patterns of the lanes, the phase adjustment patterns of the lanes are obtained in a manner that the phase adjustment patterns are shifted by a value. This value is obtained (calculated) by adding one to a value which is obtained by dividing the number of bits of the cycle of the fundamental phase adjustment pattern by the number of the phase adjustment patterns. Therefore, the phase adjustment patterns that are made of a common adjustment pattern and that are sequentially shifted relative to each other in a time domain are used in correspondence with the lanes.

Further, when the fundamental phase adjustment pattern satisfying the above condition is generated and the serial-to-parallel conversion is performed on the fundamental phase adjustment pattern to generate the phase adjustment patterns of the lanes, the phase adjustment patterns of the lanes have the following features. Namely, in this case, all data of the phase adjustment patterns of the respective lanes do not present (have) the same theoretical value at the same time. As a result, when the phase adjustment patterns of the respective lanes are transmitted in parallel from the respective plural transmission circuits to the respective receiving circuits, all the signals transmitting the phase adjustment patterns of the respective lanes do not change in the same direction (to the same theoretical value) at the same time. Because of this feature, it may become possible to effectively reduce the adverse effect on the transmission waveforms. This adverse effect may occur when all the signals transmitting the phase adjustment patterns of the respective lanes do not change in the same direction (to the same theoretical value) at the same time.

Further, as the fundamental phase adjustment pattern, random digit data may be used. As an example of the random digit data to be used as the fundamental phase adjustment pattern, a known M-sequence may be used. An example method of generating the M-sequence is described below with reference to FIG. 12.

In a data transmission system performing fast signal transmissions, it is generally requested to reduce the clock skews between a transmission side circuit and a receiving side circuit included in the data transmission system. To that end, as a clock signal to be used in the receiving side circuit in order to (more correctly) acquire data from the transmission signals, a reception clock signal may be generated by the receiving side circuit based on a transmission clock signal transmitted along with data from the transmission side circuit, so that the generated reception clock signal is used. In this case, before the receipt of the actual data, the receiving side circuit adjusts the phases of the reception clock signal in a manner that the phases of the received signal become the most appropriate phases relative to the transmission signals. Hereinafter, the adjustment so as to make the phases of the received signal relative to the transmission signals most appropriate is called “phase adjustment”. A method of performing the phase adjustment is described below. Namely, the transmission side circuit transmits a known data pattern as the phase adjustment pattern. The receiving side circuit adjusts the phases of the reception clock signal generated based on the transmission clock signal transmitted from the transmission side circuit so as to correctly receive the known data pattern.

In the following, a case is described where a method of performing the phase adjustment is applied to the data transmission system including plural lanes. In this case, when a known data pattern is (directly) used for the all lanes as the above-described phase adjustment patterns, plural signals transmitting the respective phase adjustment patterns change in the same direction (to the same theoretical value) at the same time. As a result, a voltage fluctuation occurring in the signals lines of the plural lanes may have an adverse impact on the transmission waveforms of the phase adjustment patterns, which may lead to the receiving side circuit failing to perform the phase adjustment operation.

To resolve the problem, there may be a method in which the phase adjustment pattern generation circuit is separately provided for each of the lanes. However, according to this method, it may be necessary to provide the same number of the phase adjustment pattern generation circuits as the number of the lanes. As a result, the scale of the circuit may be increased, and the cost may also be increased.

On the other hand, according to an embodiment of the present invention, a method of generating the phase adjustment patterns is provided. In this method, as the phase adjustment patterns in the data transmission system where transmission data are transmitted in parallel via the plural lanes of the signal lines, the phase adjustment patterns are provided in a manner that all the signals (voltages) of the signal lines of the respective lanes may not change in the same direction (to the same theoretical value) at the same time. Further, as a method of generating the phase adjustment patterns, a method is provided where the scale of the required circuit may not be increased.

According to an embodiment of the present invention, the transmission side circuit includes a phase adjustment pattern generation circuit that generates the phase adjustment patterns by synchronizing the fundamental phase adjustment pattern with the transmission clock signal. Namely, the fundamental phase adjustment pattern is used to generate the phase adjustment patterns of the lanes. Further, the transmission side circuit includes a serial-to-parallel conversion circuit that performs the serial-to-parallel conversion on the fundamental phase adjustment pattern to generate the phase adjustment patterns of the lanes, and allocates the generated phase adjustment patterns to the lanes. Further, the transmission side circuit includes a transmission data selection circuit that selects the data to be transmitted by switching between normal data used for a system operation and the phase adjustment pattern. On the other hand, the receiving side circuit includes a reception clock generation circuit that receives a transmission clock signal transmitted from the transmission side circuit, and generates the reception clock signal based on the transmission clock signal. Further, the receiving side circuit includes a phase adjustment pattern generation circuit that generates the phase adjustment patterns by synchronizing the fundamental phase adjustment pattern with the reception clock signal. The fundamental phase adjustment pattern is used to generate the phase adjustment patterns of the lanes. Further, the receiving side circuit includes a serial-to-parallel conversion circuit that performs the serial-to-parallel conversion on the fundamental phase adjustment pattern to generate the phase adjustment patterns of the lanes. Further, the receiving side circuit includes a pattern comparison circuit that compares the phase adjustment patterns of the lanes received from the transmission side circuit with the phase adjustment patterns of the lanes generated in the receiving side circuit. Further, the receiving side circuit includes a phase adjustment circuit that performs the phase adjustment based on the comparison result obtained by the pattern comparison circuit.

According to this embodiment, the phase adjustment patterns to be used to adjust the phases of the reception clock signal corresponding to the plural lanes of the signal lines are obtained based on a method described below. Namely, when the phase adjustment patterns corresponding to the lanes are obtained (generated) by performing the serial-to-parallel conversion on the fundamental phase adjustment pattern by the serial-to-parallel conversion circuit, the phase adjustment patterns corresponding to the lanes are generated so that the phase adjustment patterns have the following feature. Namely, when the obtained phase adjustment patterns corresponding to the lanes are transmitted, the phase adjustment patterns are allocated to the respective lanes in a manner that all the signals transmitting the phase adjustment patterns of the respective lanes do not change in the same direction (to the same theoretical value) at the same time. As a result, it may become possible to prevent the degradation of the signal quality caused by changing the signals of all the lanes in the same direction at the same time. Further, it may become possible to reduce the frequency of adjustment failure in performing the phase adjustment operation.

Further, when this method according to this embodiment is used, the number of the phase adjustment pattern circuits is one. Therefore, it may become possible to prevent the increase of the scale of the circuit necessary to prevent the degradation of the signal quality caused by the simultaneous change of the signals of all the lanes in the same direction.

In the following, an example configuration according to this embodiment of the present invention is more described in detail with reference to the accompanying drawings.

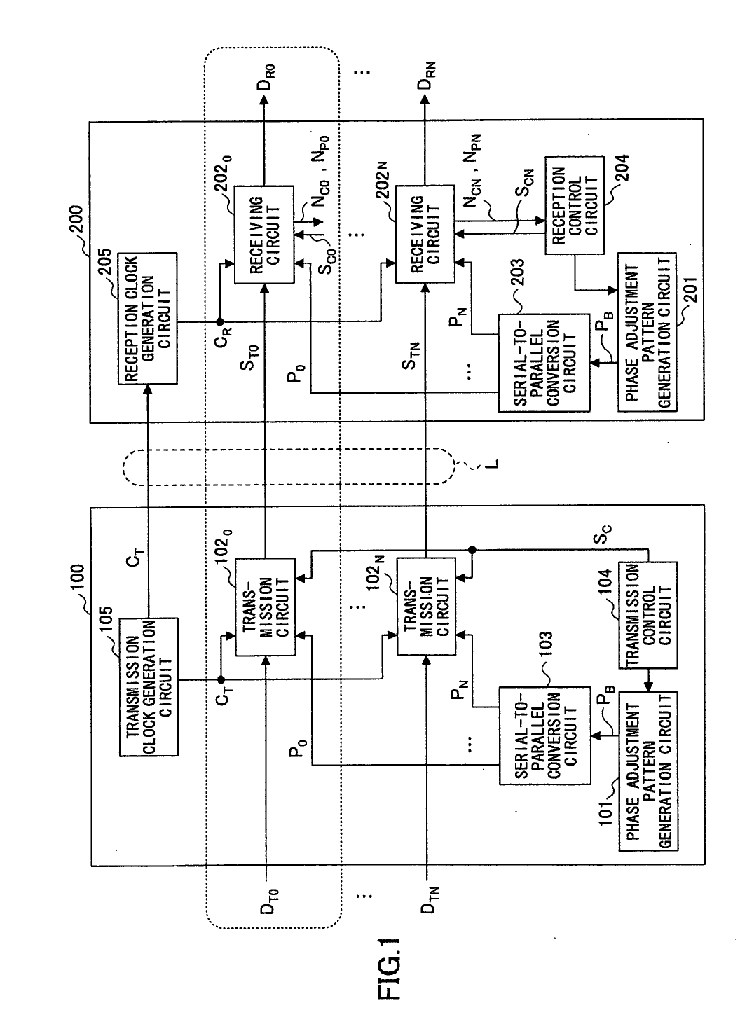

FIG. 1 is a schematic block diagram illustrating an example configuration of the data transmission system according to the embodiment of the present invention.

As illustrated in FIG. 1, the data transmission system according to the embodiment of the present invention includes a transmission side circuit 100, a receiving side circuit 200, and signal wirings L connecting between the transmission side circuit 100 and the receiving side circuit 200. The signal wirings L correspond to plural signal lines. The data transmission system may be provided (included) in an information processing apparatus and the like, and may be used for the purpose of the data transmission between various functional sections in the information processing apparatus. The various functional sections may includes, for example, a System Board (SB), a memory system interconnect, and an IO (Input/Output) unit. More specifically, for example, the transmission side circuit 100 may be provided (included) in one of the functional sections and the receiving side circuit 200 may be provided (included) in another functional section, and the transmission side circuit 100 and the receiving side circuit 200 are connected to each other via the signal wirings L or the like. As a result, in the data transmission system, the data transmission is performed between the one of the functional sections and another of the functional sections.

In FIG. 1, the transmission side circuit 100 includes transmission circuits 102₀, 102₁, 102₂, . . . , and 102_{N} corresponding to the number of the lanes (i.e., N+1 lanes), a transmission control circuit 104, a transmission clock generation circuit 105, a phase adjustment pattern generation circuit 101, and a serial-to-parallel conversion circuit 103. The transmission circuits 102₀, 102₁, 102₂, . . . , and 102_{N} transmit externally fed normal data D_{T0}, D_{T1}, D_{T2}, . . . , and D_{TN} as transmission signals S_{T0}, S_{T1}, and S_{TN}, respectively. The transmission control circuit 104 collectively controls the operations of the circuits in the transmission side circuit 100. The transmission clock generation circuit 105 generates and transmits a transmission clock signal C_{T}. The phase adjustment pattern generation circuit 101 generates a fundamental phase adjustment pattern P_{B}. The serial-to-parallel conversion circuit 103 performs the serial-to-parallel conversion on the fundamental phase adjustment pattern P_{B} to generate phase adjustment patterns P₀, P₁, P₂, . . . , and P_{N}, and supplies the adjustment patterns P₀, P₁, P₂, . . . , and P_{N} to the transmission circuits 102₀, 102₁, 102₂, . . . , and 102_{N}, respectively. The transmission circuits 102₀, 102₁, 102₂, . . . , and 102_{N} transmit the normal data D_{T0}, D_{T1}, D_{T2}, . . . , and D_{TN} or the phase adjustment patterns P₀, P₁, P₂, . . . , and P_{N}, respectively, in synchronization with the transmission clock signal C_{T}.

In FIG. 1, the receiving side circuit 200 includes receiving circuits 202₀, 202₁, 202₂, . . . , and 202_{N} corresponding to the number of the lanes (i.e., N+1 lanes), a reception control circuit 204, a reception clock generation circuit 205, a phase adjustment pattern generation circuit 201, and a serial-to-parallel conversion circuit 203. The receiving circuits 202₀, 202₁, 202₂, . . . , and 202_{N} receive the transmission signals S_{T0}, S_{T1}, S_{T2}, . . . , and S_{TN}, transmitted from the transmission circuits 102₀, 102₁, 102₂, . . . , and 102_{N}, respectively, via the signal wirings L. The receiving circuits 202₀, 202₁, 202₂, . . . , and 202_{N} extract (acquire) the normal data D_{T0}, D_{T1}, D_{T2}, . . . , and D_{TN} or the phase adjustment patterns P₀, P₁, P₂, . . . , and P_{N}, from the transmission signals S_{T0}, S_{T1}, S_{T2}, . . . , and S_{TN}, respectively. The receiving circuits 202₀, 202₁, 202₂, . . . , and 202_{N} externally supply the normal data D_{T0}, D_{T1}, D_{T2}, . . . , and D_{TN}, and perform the phase adjustment using the phase adjustment patterns P₀, P₁, P₂, . . . , and P_{N}, respectively. The reception control circuit 204 collectively controls the operations of the circuits in the receiving side circuit 200. The reception clock generation circuit 205 receives the transmission clock signal C_{T}, generates a reception clock signal C_{R}, and supplies the generated reception clock signal C_{R} to the receiving circuits 202₀, 202₁, 202₂, . . . , and 202_{N}. The phase adjustment pattern generation circuit 201 generates a fundamental phase adjustment pattern P_{B} similar to the fundamental phase adjustment pattern P_{B} generated by the phase adjustment pattern generation circuit 101 of the transmission side circuit 100. The serial-to-parallel conversion circuit 203 performs the serial-to-parallel conversion on the fundamental phase adjustment pattern P_{B} to generate phase adjustment patterns P₀, P₁, P₂, . . . , and P_{N}, and supplies the generated adjustment patterns P₀, P₁, P₂, . . . , and P_{N} to the receiving circuits 202₀, 202₁, 202₂, . . . , and 202_{N}, respectively. The receiving circuits 202₀, 202₁, 202₂, . . . , and 202_{N} extract the normal data D_{T0}, D_{T1}, D_{T2}, . . . , and D_{TN} or the phase adjustment patterns P₀, P₁, P₂, . . . , and P_{N}, from the transmission signals S_{T0}, S_{T1}, S_{T2}, . . . , and S_{TN}, respectively, using the reception clock signal C_{R}.

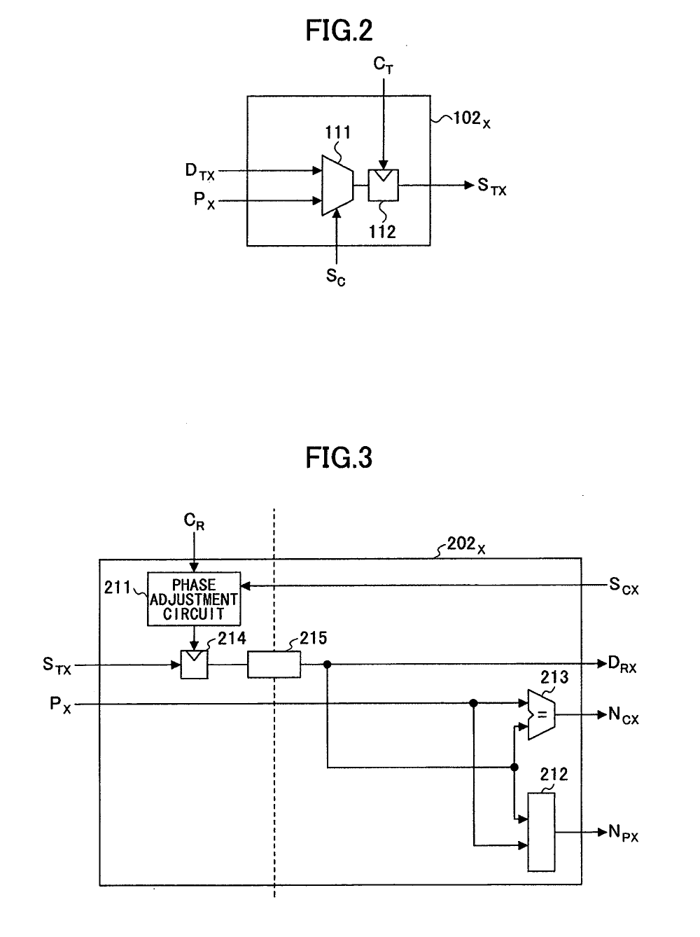

FIG. 2 is an example circuit diagram illustrating each of the transmission circuits 102₀, 102₁, 102₂, . . . , and 102_{N}. Each transmission circuit 102_{X} (i.e., X: 1 through N) includes a transmission data selection circuit 111 and a flip-flop circuit 112 to hold data in the flip-flop circuit 112. The transmission data selection circuit 111 selects the normal data D_{TX} or the phase adjustment patterns P_{X}, and transmits the selected normal data D_{TX} or phase adjustment patterns P_{X} to the flip-flop circuit 112 under the control of the transmission control circuit 104. The flip-flop circuit 112 transmits the normal data D_{TX} supplied from the transmission data selection circuit 111 or the phase adjustment patterns P_{X} supplied from the serial-to-parallel conversion circuit 103 in synchronization with the transmission clock signal C_{T}.

FIG. 3 is an example circuit diagram illustrating each of the receiving circuits 202₀, 202₁, 202₂, . . . , and 202_{N}. Each receiving circuit 202_{X} (X: 1 through N) includes a phase adjustment circuit 211, a preamble detection circuit 212, a pattern comparison circuit 213, a flip-flop circuit 214, and a FIFO (First-In First-Out circuit) 215. The phase adjustment circuit 211 is controlled by the reception control circuit 204 based on a phase adjustment control signal S_{CX}, and adjusts and optimizes the phase of the reception clock signal C_{R}. The reception clock signal C_{R} is supplied from the reception clock generation circuit 205. Further, the phase adjustment circuit 211 supplies the reception clock signal C_{R} where the phases are adjusted (phase-adjusted reception clock signal C_{R}) to the flip-flop circuit 214. The flip-flop circuit 214 extracts the normal data D_{TX} or the phase adjustment pattern P_{X} from the transmission signal S_{TX}, and supplies the extracted normal data D_{TX} or the phase adjustment pattern P_{X} to the FIFO 215. The FIFO 215 externally supplies the normal data (transmission data) D_{TX} as received data D_{RX} by synchronizing the normal data (transmission data) D_{TX} with the reception clock signal C_{R}. The normal data (transmission data) D_{TX} are received from the flip-flop circuit 214. Further, the FIFO 215 supplies the phase adjustment pattern P_{X} to the pattern comparison circuit 213 and the preamble detection circuit 212 by synchronizing the phase adjustment pattern P_{X} with the reception clock signal C_{R}.

The pattern comparison circuit 213 compares the phase adjustment pattern P_{X} supplied from the FIFO 215 with the phase adjustment pattern P_{X} supplied from the serial-to-parallel conversion circuit 203 to determine whether those patterns correspond to each other. When determining that the phase adjustment pattern P_{X} supplied from the FIFO 215 corresponds to the phase adjustment pattern P_{X} supplied from the serial-to-parallel conversion circuit 203, the pattern comparison circuit 213 supplies a pattern correspondence report signal N_{CX} to the reception control circuit 204.

The preamble detection circuit 212 receives a preamble pattern PA of the phase adjustment pattern P_{X} supplied from the serial-to-parallel conversion circuit 203. The preamble pattern PA is described below. The preamble detection circuit 212 compares the preamble pattern PA with the phase adjustment pattern P_{X} supplied from the FIFO 215 to determine whether those correspond to each other. When determining that preamble pattern PA corresponds to the phase adjustment pattern P_{X} supplied from the FIFO 215, the preamble detection circuit 212 supplies a preamble detection report signal N_{PN} to the reception control circuit 204.

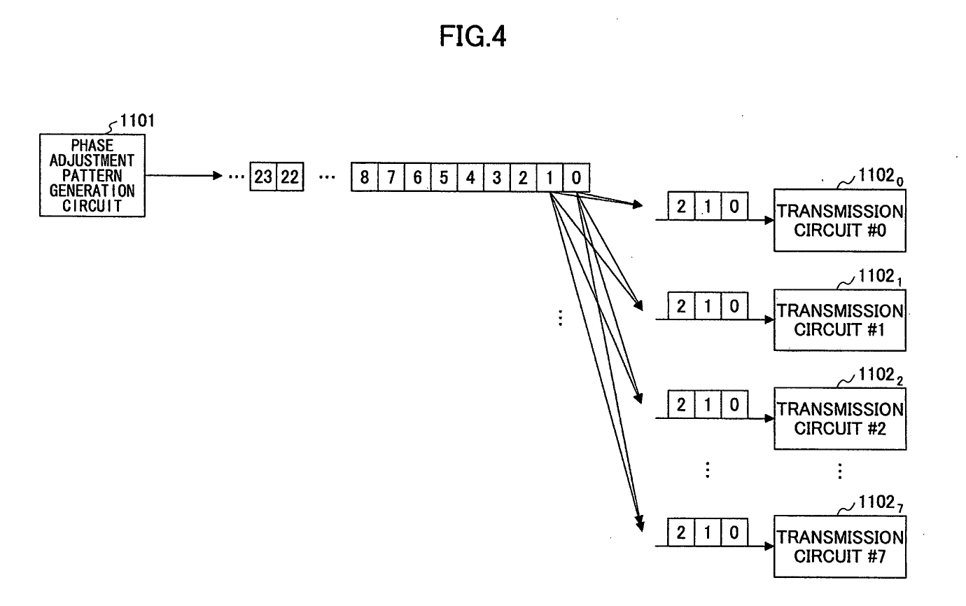

Next, details of a method of generating the phase adjustment patterns according to the embodiment of the present invention are described. For explanatory purposes, a method of generating the phase adjustment patterns according to a reference example is described with reference to FIG. 4. In the reference example of FIG. 4, a phase adjustment pattern generation circuit 1101 generates the phase adjustment patterns of the respective lanes. Then, the generated phase adjustment patterns are transmitted to the respective transmission circuits 1102₀, 1102₁, 1102₂, . . . , and 1102₇. As a result, those phase adjustment patterns are similar to each other.

Therefore, the signals transmitting those phase adjustment patterns always have the same signal value (theoretical value), and the signal values always change in the same direction at the same time. As a result, as described above, a voltage fluctuation occurring in the signals lines of the plural lanes may have an adverse impact on the transmission waveforms of the phase adjustment patterns, which may eventually lead to the receiving side circuit failing to perform the phase adjustment operation.

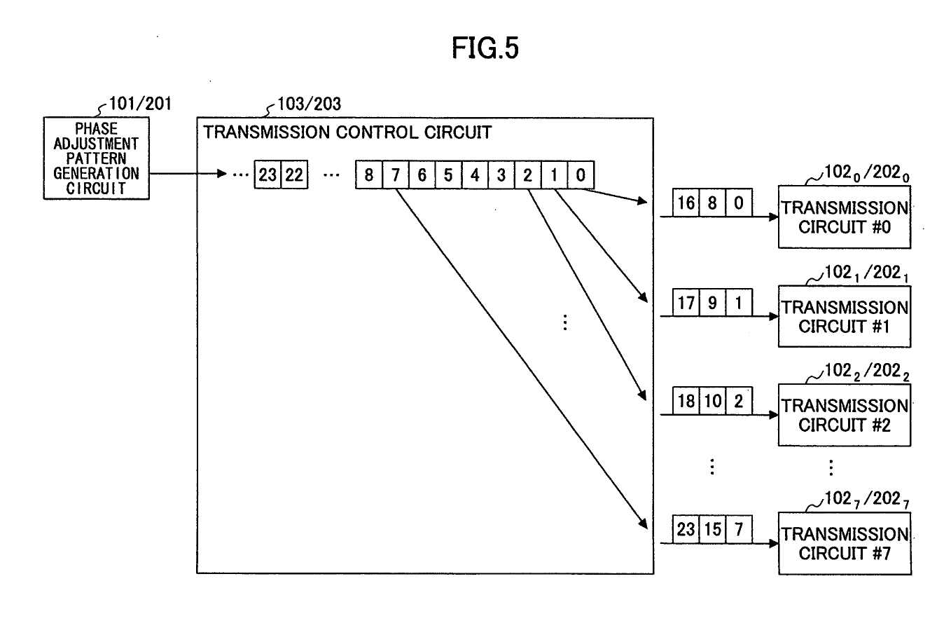

Next, a method of generating the phase adjustment patterns according to the embodiment of the present invention is described with reference to FIGS. 5 through 7. FIG. 5 illustrates the functions of the serial-to-parallel conversion circuit 103 of the transmission side circuit 100. The serial-to-parallel conversion circuit 203 of the receiving side circuit 200 has the functions similar to those in the serial-to-parallel conversion circuit 103. Upon receiving the fundamental phase adjustment pattern generated by the phase adjustment pattern generation circuit 101, the serial-to-parallel conversion circuit 103 sequentially allocates the bits included in the fundamental phase adjustment pattern to the transmission circuits 102₀, 102₁, 102₂, . . . , and 102₇. This allocation is repeatedly performed in the order of transmission circuits 102₀, 102₁, 102₂, . . . , and 102₇.

Namely, first, the bit values of the bit numbers 0 through 7 of the fundamental phase adjustment pattern are sequentially allocated to the transmission circuits 102₀, 102₁, 102₂, . . . , and 102₇, respectively. Next, the bit values of the bit numbers 8 through 15 of the fundamental phase adjustment pattern are sequentially allocated to the transmission circuits 102₀, 102₁, 102₂, . . . , and 102₇, respectively. Next, the bit values of the bit numbers 16 through 23 of the fundamental phase adjustment pattern are sequentially allocated to the transmission circuits 102₀, 102₁, 102₂, . . . , and 102₇, respectively. After that, a similar operation described above is repeated.

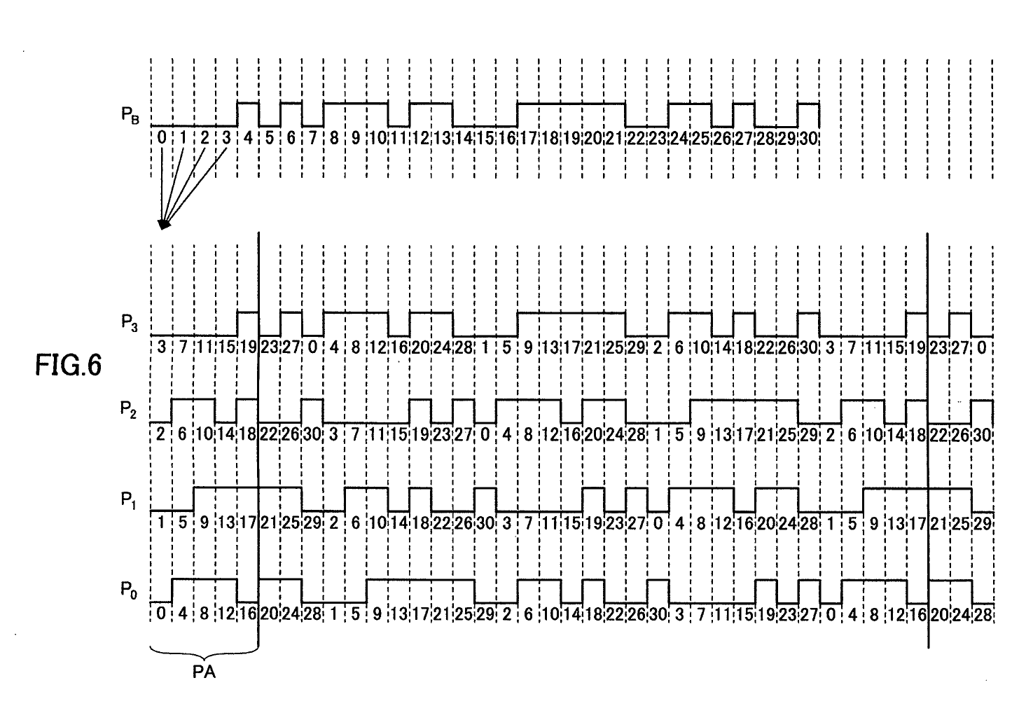

FIG. 6 further illustrates the operations of the serial-to-parallel conversion circuit 103 using an actually applicable bit pattern as the fundamental phase adjustment pattern. FIG. 6 illustrates one cycle of a fundamental phase adjustment pattern P_{B} as an example of generated fundamental phase adjustment pattern P_{B}. In the fundamental phase adjustment pattern P_{B} of FIG. 6, the numbers 0 through 30 indicate the respective bit numbers. Further, a bit value “0” is indicated by the low level and a bit value “1” is indicated by the high level. Therefore, in the fundamental phase adjustment pattern P_{B} of FIG. 6, the bit values of the bit numbers 0 through 30 are “0000101011101100011111001101001”. Therefore, one cycle (the number of the bits of the cycle, or length) of the fundamental phase adjustment pattern P_{B} is 31 (bits).

Further, in the example of FIG. 3, the number of lanes to which the fundamental phase adjustment pattern P_{B} is allocated is 4. Herein, the number of bits of the cycle of the fundamental phase adjustment pattern P_{B} and the number of lanes to which the fundamental phase adjustment pattern P_{B} is allocated are determined in a manner that the number of bits of the cycle of the fundamental phase adjustment pattern P_{B} and the number of lanes to which the fundamental phase adjustment pattern P_{B} is allocated are relatively prime to each other. In other words, the number of bits of the cycle of the fundamental phase adjustment pattern P_{B} and the number of lanes to which the fundamental phase adjustment pattern P_{B} is allocated are determined in a manner that the greatest common factor between the number of bits of the cycle of the fundamental phase adjustment pattern P_{B} and the number of lanes to which the fundamental phase adjustment pattern P_{B} is 1. In the example of FIG. 6, as described above, the number of bits of the cycle is 31 and the number of the lanes is 4. There is no common factor other than 1 between the numbers 31 and 4. Therefore, the numbers 31 and 4 are relatively prime to each other.

The serial-to-parallel conversion circuit 103 performs the serial-to-parallel conversion on the fundamental phase adjustment pattern P_{B} to generate phase adjustment patterns P₀, P₁, P₂, and P₃, and allocates the generated phase adjustment patterns P₀, P₁, P₂, and P₃ to the four lanes (hereinafter referred to as lanes R₀, R₁, R₂, and R₃), respectively. Namely, as illustrated in FIG. 6, the bit values (bit data) of the first four bits (i.e., bit numbers 0 through 3) of the fundamental phase adjustment pattern P_{B} are sequentially allocated as the first bits of the phase adjustment patterns P₀, P₁, P₂, and P₃ corresponding to the lanes R₀, R₁, R₂, and R₃. In the same manner, the bit values of the next four bits (i.e., bit numbers 4 through 7) of the fundamental phase adjustment pattern P_{B} are sequentially allocated as the next bits of the phase adjustment patterns P₀, P₁, P₂, and P₃ of the lanes R₀, R₁, R₂, and R₃. After that, a similar operation described above is repeated. After all of the 31 bits of the fundamental phase adjustment pattern P_{B} are allocated in the manner as described above, the bit values of the fundamental phase adjustment pattern P_{B} are sequentially allocated to the lanes R₀, R₁, R₂, and R₃ in the same manner from the first bit (i.e., bit number 1) again.

In this case, as described above, the number of bits of one cycle of the fundamental phase adjustment pattern P_{B} and the number of the lanes are determined in a manner that those numbers are relatively prime to each other. By determining in this way, when the bit values of the bits of the fundamental phase adjustment pattern P_{B} are sequentially allocated to the phase adjustment patterns P₀, P₁, P₂, and P₃ of the lanes R₀, R₁, R₂, and R₃ in this order as described above, the 31^{st} bit (i.e. the last bit) of the first cycle of the fundamental phase adjustment pattern P_{B} is not allocated to the fourth lane R₃ (i.e., the last lane). Therefore, the first bit of the next (i.e., the second) cycle of the fundamental phase adjustment pattern P_{B} is not allocated to the first phase adjustment pattern P₀ of the first lane R₀. In the example of FIG. 6, the 31^{st} bit (i.e. the bit number 30) of the first cycle of the fundamental phase adjustment pattern P_{B} is allocated to the third phase adjustment pattern P₂ of the third lane R₂. Accordingly, the first bit (bit number “0”) of 31 bits of the next cycle (second cycle) of the fundamental phase adjustment pattern P_{B} is allocated to the fourth phase adjustment pattern P₃ of the fourth lane R₃. In the same manner, the 31^{st} bit (i.e. the bit number 30) of the second cycle of the fundamental phase adjustment pattern P_{B} is allocated to the second phase adjustment pattern P₁ of the second lane R₁. Accordingly, the first bit (bit number “0”) of 31 bits of the third cycle of the fundamental phase adjustment pattern P_{B} is allocated to the third phase adjustment pattern P₂ of the third lane R₂. After that, the bit data are allocated in the same manner as describe above.

Herein, as illustrated in FIG. 6, the phase adjustment patterns P₀, P₁, P₂, and P₃ of the lanes R₀, R₁, R₂, and R₃ are shifted by a (predetermined) number of bits. The number is obtained by adding one to a value which is the quotient obtained by dividing the number of bits of the cycle by the number of lanes. In the example of FIG. 6, as described above, the number of bits of the cycle is 31 and the number of the lanes is 4. Therefore, the number which is obtained by adding one to the quotient obtained by dividing the number of bits of the cycle by the number of lanes is eight (i.e., 31/4+1=8). Therefore, in FIG. 6, the bits numbers of the fundamental phase adjustment pattern P_{B} present in the phase adjustment pattern P₃ of the fourth lane R₃ are 3, 7, 1, 15, 19, 23, 27, 0, and 4 in this order. On the other hand, the bits numbers of the fundamental phase adjustment pattern P_{B} present in the phase adjustment pattern P₂ of the third lane R₂ are 2, 6, 10, 14, 18, 22, 26, 30, 3, 7, 1, 15, 19, 23, 27, 0, and 4 in this order. Namely, the first to the eighth bit values of the phase adjustment pattern P₃ of the fourth lane R₃ correspond to the ninth to the sixteenth bit values of the phase adjustment pattern P₂ of the third lane R₂. Namely, the phase adjustment pattern P₂ of the third lane R₂ is shifted from the phase adjustment pattern P₃ of the fourth lane R₃ by eight bits. In the same manner, the phase adjustment pattern P₁ of the second lane R₁ is shifted from the phase adjustment pattern P₂ of the third lane R₂ by eight bits. Also, the phase adjustment pattern P₀ of the first lane R₀ is shifted from the phase adjustment pattern P₁ of the second lane R₁ by eight bits.

As described above, when the above condition is satisfied that the number of bits of the cycle of the fundamental phase adjustment pattern and the number of the lanes to which the fundamental phase adjustment pattern is allocated are relatively prime to each other, the phase adjustment patterns allocated to the respective lanes are generated in a manner that the phase adjustment patterns have a common pattern and are shifted by a predetermined number of bits relevant to each other. Because of this feature, it may become possible to perform the phase adjustment using the phase adjustment patterns having a common pattern and shifted by a predetermined number of bits relevant to each other.

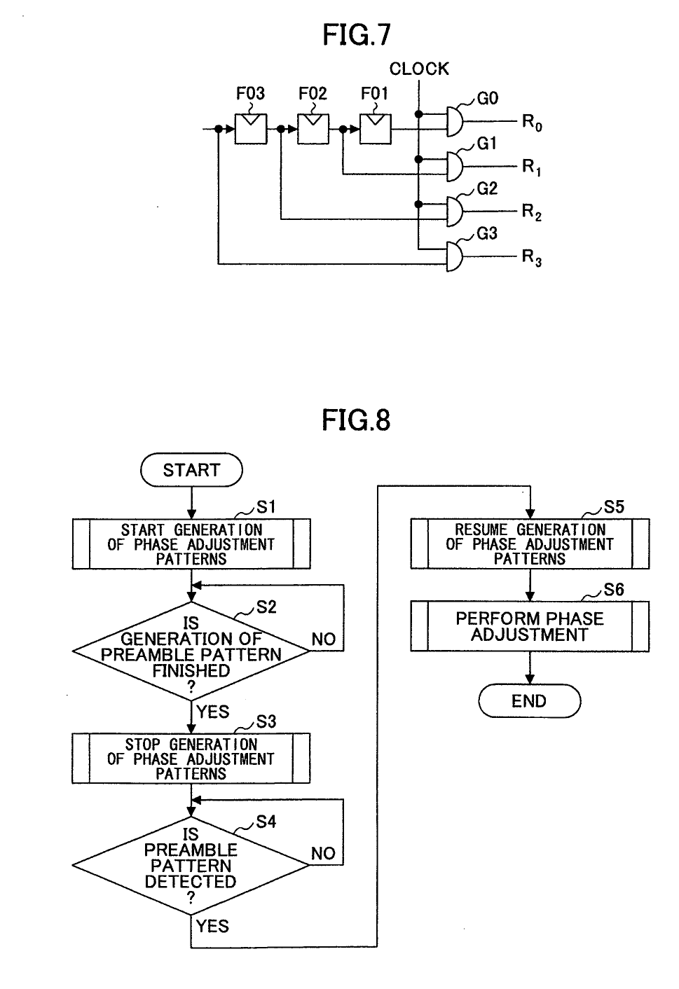

FIG. 7 illustrates an example circuit of the serial-to-parallel conversion circuits 103 and 203. In the example circuit, three flip-flop circuits F01, F02, and F03 are connected in series to form a shift register, so that the fundamental phase adjustment pattern P_{B} is input to the input terminal of the flip-flop circuit F03. In the shift register, the bit values of the fundamental phase adjustment pattern P_{B} are sequentially shifted (i.e., bit by bit) in the arranging order (direction) of the flip-flop circuits F03, F02, and F01. The outputs of the of the flip-flop circuits F01, F02, and F03 are connected to one (the first) input terminals of the AND circuits G0, G1, and G2, respectively. The AND circuits G0, G1, and G2 calculate the respective logical products as the respective gates. Further, the input terminal of the flip-flop circuit F03 is connected to the first input terminal of the AND circuit G3 as the gate.

Further, the outputs of the AND circuits G0, G1, G2, and G3 are allocated to the lanes R₀, R₁, R₂, and R₃, respectively. Further, a clock signal which becomes a high level once every four bits of the fundamental phase adjustment pattern P_{B} input to the flip-flop circuit F03 is input to the other (the second) input terminals of the AND circuits G0, G1, G2, and G3. When the fundamental phase adjustment pattern P_{B} of FIG. 6 is input to the flip-flop circuit F03, after a time period corresponding to three bits has passed, the bit values of the first four bits of the fundamental phase adjustment pattern P_{B} are input in the first input terminals of the AND circuits G0, G1, G2, and G3, respectively. Further, at this timing, the high-level clock signal is input to the second input terminals of the AND circuits G0, G1, G2, and G3. As a result, the bit values of the first four bits of the fundamental phase adjustment pattern P_{B} are allocated (applied) to the lanes R₀, R₁, R₂, and R₃, respectively. After that, in a time period corresponding to four bits, the bit values of the next four bits of the fundamental phase adjustment pattern P_{B} are input to the first terminals of the AND circuits G0, G1, G2, and G3, respectively. At this timing, by inputting the high-level clock signal to the second input terminals of the AND circuits G0, G1, G2, and G3, those four bits of the fundamental phase adjustment pattern P_{B} are allocated to the lanes R₀, R₁, R₂, and R₃, respectively. After that, a similar operation as described above is repeated, and the bit values of the bits included in the fundamental phase adjustment pattern P_{B} are sequentially allocate to the lanes R₀, R₁, R₂, and R₃ in this order as the phase adjustment patterns P₀, P₁, P₂, and P₃, respectively.

Next, a procedure of the phase adjustment operation in the receiving side circuit 200 is described with reference to FIG. 8. In FIG. 8, in step S1, according to the instructions from the reception control circuit 204, the phase adjustment pattern generation circuit 201 of the receiving side circuit 200 starts generating the fundamental phase adjustment pattern P_{B}. Further, the serial-to-parallel conversion circuit 203 performs the serial-to-parallel conversion on the fundamental phase adjustment pattern P_{B} to generate the phase adjustment patterns corresponding to the lanes. After that, the phase adjustment pattern generation circuit 201 and the serial-to-parallel conversion circuit 203 determine whether the preamble pattern PA which indicates a header part of the respective phase adjustment patterns is generated (step S2). As a result of the determination in step S2, when determining that the preamble pattern PA is generated, the reception control circuit 204 performs control to cause the phase adjustment pattern generation circuit 201 and the serial-to-parallel conversion circuit 203 to stop generating the phase adjustment patterns (step S3). At the same time, the reception control circuit 204 instructs (performs control to cause) the preamble detection circuits 212 of the respective receiving circuits 202₀, 202₁, 202₂, . . . , and 202_{N} to start detecting the preamble pattern PA.

Upon detecting the preamble pattern PA in the data supplied from the FIFO 215, the preamble detection circuits 212 of the respective receiving circuits transmit the preamble detection report signal N_{PN} to the reception control circuit 204. The reception control circuit 204 determines whether the preamble detection report signal N_{PN} is received from one or more of the receiving circuits (step S4). As a result of the determination in step S4, when determining that the preamble detection report signal N_{PN} is received from one or more of the receiving circuits, the reception control circuit 204 transmits a phase adjustment control signal S_{CN} to all the receiving circuits 202₀, 202₁, 202₂, . . . , 202_{N} to instruct the receiving circuits 202₀, 202₁, 202₂, . . . , and 202_{N} to start the phase adjustment operation. At the same time, the reception control circuit 204 instructs the phase adjustment pattern generation circuit 201 and the serial-to-parallel conversion circuit 203 to resume generating the phase adjustment patterns (step S5).

A reason to stop the generation of the phase adjustment patterns upon the generation of the preamble pattern PA in step S3 and to resume generating the phase adjustment patterns in step S5 is as follows. The pattern comparison circuit 213 of the receiving circuits 202₀, 202₁, 202₂, . . . , and 202_{N} compares the phase adjustment pattern P_{X} supplied from the FIFO 215 with the phase adjustment pattern P_{X} supplied from the serial-to-parallel conversion circuit 203. Herein, the phase adjustment pattern P_{X} supplied from the FIFO 215 is the phase adjustment pattern P_{X} extracted from the transmission signal S_{TX} using the reception clock signal C_{R}. On the other hand, the phase adjustment pattern P_{X} supplied from the serial-to-parallel conversion circuit 203 is generated (acquired) by performing the serial-to-parallel conversion on the fundamental phase adjustment pattern P_{B} by the serial-to-parallel conversion circuit 203. The fundamental phase adjustment pattern P_{B} is generated by the phase adjustment pattern generation circuit 201. When the preamble pattern PA is detected in the phase adjustment pattern P_{X} extracted from the transmission signal S_{TX} in step 4 of FIG. 8, the phase adjustment operation is started in each of the receiving circuits 202₀, 202₁, 202₂, . . . , and 202_{N} (step S6). Therefore, the pattern supplied from the pattern comparison circuits 213 to the FIFO 215 after the phase adjustment operation is started represents a part of the phase adjustment pattern after the preamble pattern PA. Further, the generation of the phase adjustment patterns is (temporarily) stopped when the preamble pattern PA is generated in step S3, and the generation of the phase adjustment patterns is resumed in step S5. Therefore, the pattern supplied from the pattern comparison circuits 213 to the FIFO 215 after the generation of the phase adjustment patterns is resumed also represents the part of the phase adjustment pattern after the preamble pattern PA. Therefore, the part of the phase adjustment pattern supplied from the FIFO 215 and the part of the phase adjustment pattern supplied from the serial-to-parallel conversion circuit 203 correspond to each other. Therefore, the parts of the phase adjustment pattern corresponding to each other are compared by the pattern comparison circuits 213. As a result, it may become possible to improve the efficiency of the phase adjustment operation.

When determining that the phase adjustment patterns do not correspond to each other, the phase adjustment circuits 211 of the respective receiving circuits 202₀, 202₁, 202₂, . . . , and 202_{N} adjust the phase of the reception clock signal C_{R}, and supply the adjusted reception clock signal C_{R} to the respective flip-flop circuits 214. In this adjustment operation, the phase adjustment circuit 211 adjusts the phase of the reception clock signal C_{R} to be supplied to the flip-flop circuit 214 in a manner that the phase of the reception clock signal C_{R} is optimized in consideration of the relationship with phase of the transmission signal S_{TX} input to the flip-flop circuit 214. Namely, as a result of this phase adjustment of the reception clock signal C_{R}, it may become possible to more reliably extract the phase adjustment pattern from the transmission signal S_{TX}. As a result, the phase adjustment pattern extracted from the transmission signal S_{TX} may more reliably correspond to the phase adjustment pattern supplied from the serial-to-parallel conversion circuit 203.

When determining that the phase adjustment pattern extracted from the transmission signal S_{TX} corresponds to the phase adjustment pattern supplied from the serial-to-parallel conversion circuit 203 as a result of the phase adjustment of the reception clock signal C_{R}, the pattern comparison circuits 213 transmits the pattern correspondence report signal N_{CX} to the reception control circuit 204. After a predetermined time period needed to perform the phase adjustment operation on the lanes has passed, the reception control circuit 204 terminates the phase adjustment operation (step S6). Herein, for example, the phase adjustment operation in step S6 may be performed as described below. Namely, in each of the lanes, the reception control circuit 204 causes the phase adjustment circuit 211 to gradually change the phase of the clock signal (reception clock signal C_{R}) to be supplied to the flip-flop circuit 214 in one direction. In this case, even when the pattern correspondence report signal N_{CX} is received from the pattern comparison circuits 213, the reception control circuit 204 continues to gradually change the phase of the clock signal in the direction same as the above one direction. After that, the reception control circuit 204 causes the phase adjustment circuit 211 to gradually change the phase of the clock signal (reception clock signal C_{R}) to be supplied to the flip-flop circuit 214 in the direction opposite to the above one direction. In this case, again, even when the pattern correspondence report signal N_{CX} is received from the pattern comparison circuits 213, the reception control circuit 204 continues to gradually change the phase of the clock signal in the direction opposite to the above one direction. As described above, by repeating changing the phase in one direction and in the direction opposite to the one direction, the reception control circuit 204 may acquire an optimal phase of the clock signal. The “predetermined time period needed to perform the phase adjustment operation on the lanes” described above refers to the time period thought to be necessary to acquire the optimal phase of the clock signal in each of the lanes.

Herein, the preamble pattern PA refers to a pattern uniquely determined in one cycle of the phase adjustment pattern corresponding to each of the lanes and previously determined in correspondence with each of the lanes. In this embodiment, the first five bits of the phase adjustment patterns corresponding to the lanes are used as the respective preamble patterns PA (see FIG. 6). Further, in this embodiment, the number of the lanes is four. Therefore, the first five bits of the phase adjustment patterns corresponding to the four lanes refer to the first 20 bits of the fundamental phase adjustment pattern P_{B} (5×4=20). Further, in this embodiment, it is assumed that the length (i.e., the number of bits of one cycle) of the fundamental phase adjustment pattern P_{B} is determined in a manner that the number of bits of one cycle of the fundamental phase adjustment pattern P_{B} is not divisible by the number of the lanes. This condition is simultaneously satisfied when the above condition is satisfied that the number of bits of the cycle of the fundamental phase adjustment pattern and the number of the lanes to which the fundamental phase adjustment pattern is allocated are relatively prime to each other. Further, under that condition, in each of the lanes, the phase adjustment pattern having the length (i.e., the number of bits of one cycle) of the phase adjustment pattern is output. As a result, the patterns having a common pattern and shifted (by a predetermined number of bits) relative to each other are allocated to the respective lanes. In the example of FIG. 6, one cycle of the fundamental phase adjustment pattern P_{B} has 31 bits. Therefore, the phase adjustment patterns P₀, P₁, P₂, and P₃ of the respective lanes have 31 bits. Therefore, as described above, for example, the first 31 bits of the first bit numbers 1 through 31 in the phase adjustment pattern P₃ are the same as the 31 bits of the bit numbers 9 through 39 in the phase adjustment pattern P₂ which is shifted from the phase adjustment pattern P₃ by eight bits. In the same manner, the 31 bits of the bit numbers 9 through 39 in the phase adjustment pattern P₂ are the same as the 31 bits of the bit numbers 17 through 47 in the phase adjustment pattern P₁ which is shifted from the phase adjustment pattern P₂ by eight bits. In the same manner, the 31 bits of the bit numbers 17 through 47 in the phase adjustment pattern P₁ are the same as the 31 bits of the bit numbers 25 through 55 in the phase adjustment pattern P₀ which is shifted from the phase adjustment pattern P₁ by eight bits.

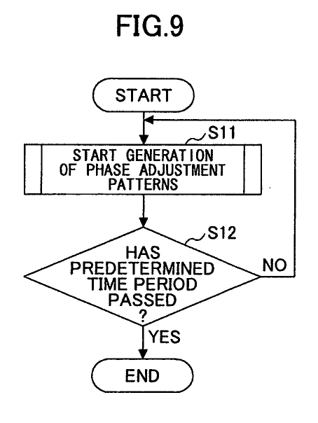

Next, a procedure of the phase adjustment operation in the transmission side circuit 100 is described with reference to FIG. 9. This procedure in the transmission side circuit 100 corresponds to the procedure of the phase adjustment operation in the receiving side circuit 200 described above with reference to FIG. 8. First, in step S11, upon the receipt of the instructions from the transmission control circuit 104, the phase adjustment pattern generation circuit 101 starts generating the fundamental phase adjustment pattern and the serial-to-parallel conversion circuit 103 starts generating the phase adjustment patterns of the respective lanes. After that, when determining that a predetermined time period has passed (YES in step S12), the transmission control circuit 104 causes the phase adjustment pattern generation circuit 101 and the serial-to-parallel conversion circuit 103 to stop generating the fundamental phase adjustment pattern and the phase adjustment patterns of the respective lanes. As the predetermined time period, for example, a time period thought to be needed to perform the phase adjustment operations corresponding to the lanes in the receiving side circuit 200 may be used.

As described above, the phase adjustment pattern generation circuit 101 generates the fundamental phase adjustment pattern P_{B} and transmits the generated fundamental phase adjustment pattern P_{B} to the serial-to-parallel conversion circuit 103. The serial-to-parallel conversion circuit 103 performs the serial-to-parallel conversion on the fundamental phase adjustment pattern P_{B} to generate the phase adjustment patterns P₀, P₁, P₂, . . . , and P_{N}. In this case, the serial-to-parallel conversion is performed by the method described with reference to FIGS. 5, 6, and 7. The generated phase adjustment patterns P₀, P₁, P₂, . . . , and P_{N} are allocated to the transmission circuits 102₀, 102₁, 102₂, . . . , and 102_{N}, respectively. The fundamental phase adjustment pattern P_{B} is generated periodically. Therefore, the phase adjustment patterns P₀, P₁, P₂, . . . , and P_{N} corresponding to the lanes are also generated periodically. A similar method as the method of generating the phase adjustment patterns P₀, P₁, P₂, . . . , and P_{N} corresponding to the lanes is also performed in the phase adjustment pattern generation circuit 201 and the serial-to-parallel conversion circuit 203 in the receiving side circuit 200. Because of this feature, the phase adjustment patterns P₀, P₁, P₂, . . . , and P_{N} generated in the receiving side circuit 200 are the same as the phase adjustment patterns P₀, P₁, P₂, . . . , and P_{N} generated in the transmission side circuit 100, respectively. As a result, after the detection of the preamble patterns PA, the part of the patterns of the respective transmission signals after the respective preamble patterns PA and the part of the pattern after the preamble patterns PA transmitted from the serial-to-parallel conversion circuit 203 are supplied to the respective receiving circuits 202₀, 202₁, 202₂, . . . , and 202_{N} in the receiving side circuit 200.

The transmission circuits 102₀, 102₁, 102₂, . . . , and 102_{N} transmit the generated phase adjustment patterns P₀, P₁, P₂, . . . , and P_{N} of the respective lanes as the transmission signals S_{T0}, S_{T1}, S_{T2}, . . . , and S_{TN}, via the signal wirings L. In this case, the transmission circuits 102₀, 102₁, 102₂, . . . , and 102_{N} start transmitting the phase adjustment patterns P₀, P₁, P₂, . . . , and P_{N} upon receiving the instructions from the transmission control circuit 104 to start the phase adjustment operation.

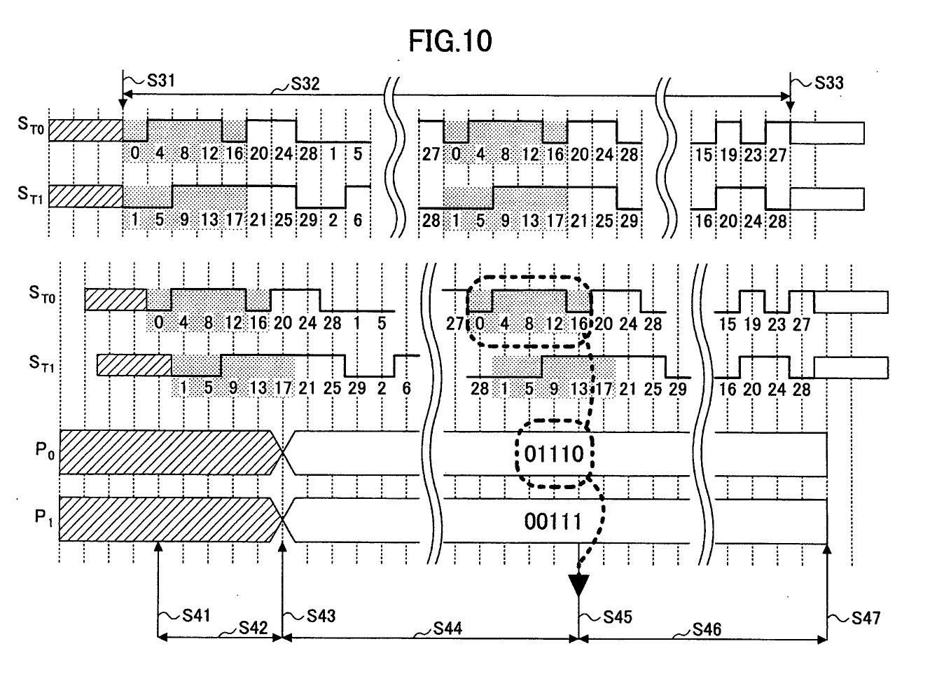

Next, the phase adjustment operation described above with reference to FIGS. 8 and 9 is further described in a time frame with reference to FIG. 10. First, in step S31 of FIG. 10, the transmission side circuit 100 starts generating and transmitting the phase adjustment patterns P₀, P₁, P₂, . . . , and P_{N}. As a result, in step S32, the phase adjustment patterns P₀, P₁, P₂, . . . , and P_{N} are transmitted as the transmission signals S_{T0}, S_{T1}, S_{T2}, . . . , and S_{TN} of the respective lanes. Then, in step S33, when the predetermined time period has passed, the transmission side circuit 100 (temporarily) stops the generation and the transmission of the phase adjustment patterns P₀, P₁, P₂, . . . , and P_{N}.

On the other hand, the receiving side circuit 200 receives the transmission signals S_{T0}, S_{T1}, S_{T2}, . . . , and S_{TN}, and starts generating the phase adjustment patterns in step S41. Then, in step S42, the preamble patterns PA are generated. Next, in step S43, the generation of the phase adjustment patterns is stopped. Herein, the “the generation of the phase adjustment patterns” refers to the operation in which the phase adjustment pattern generation circuit 201 generates the fundamental phase adjustment pattern P_{B} and the serial-to-parallel conversion circuit 203 generates the phase adjustment patterns P₀, P₁, P₂, . . . , and P_{N}, corresponding to lanes based on the fundamental phase adjustment pattern P. After that, in step S44, the detection of the preamble patterns PA in the received transmission signals S_{T0}, S_{T1}, S_{T2}, . . . , and S_{TN} is being waited for.

In step S45, when the preamble patterns PA are detected in the received transmission signals S_{T0}, S_{T1}, S_{T2}, . . . , and S_{TN}, the receiving circuits 202₀, 202₁, 202₂, . . . , and 202_{N} in the receiving side circuit 200 start the phase adjustment operation in step S46. Then, when the predetermined time period has passed which is thought to be needed to perform the phase adjustment operation corresponding to each of the lanes, the reception control circuit 204 causes the phase adjustment circuits 211 corresponding to the lanes to stop the phase adjustment operation in step S47. Herein, in the case described with reference to FIG. 6, as illustrated in FIG. 10, the data (bit values) of the preamble pattern PA of the phase adjustment pattern P₀ of the first lane R₀ are “01110”, and the data of the preamble pattern PA of the phase adjustment pattern P₁ of the second lane R₁ are “00111”. FIG. 10 illustrates a case where the data “01110” are detected as the data of the preamble pattern PA of the phase adjustment pattern P₀ based on the corresponding transmission signal S_{T0}. At that detection timing, the phase adjustment circuits 211 of the respective receiving circuits 202₀, 202₁, 202₂, . . . , and 202_{N} start the phase adjustment operation.

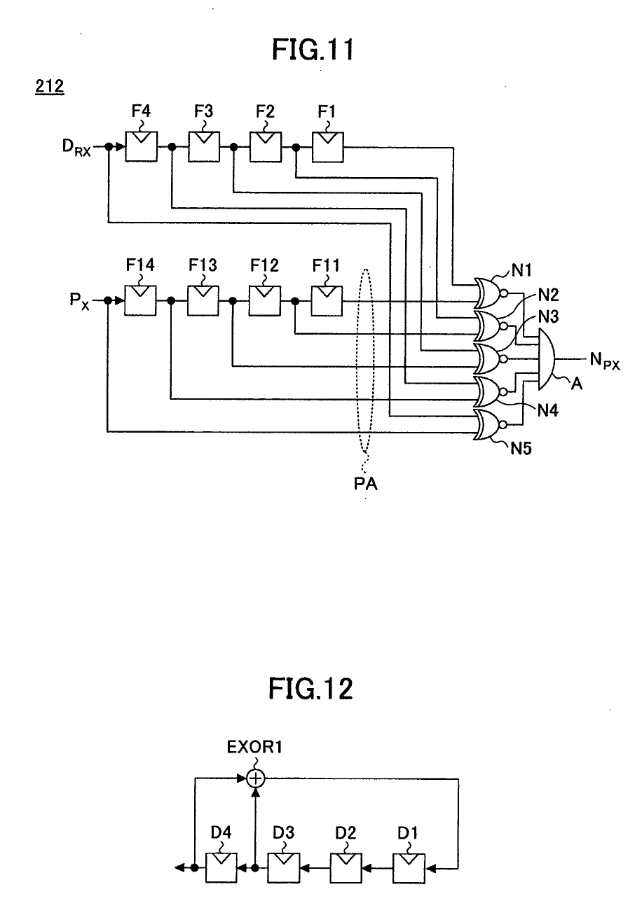

Next, an example of the preamble detection circuits 212 of the respective receiving circuits is described with reference to FIG. 11. In this example of FIG. 11, the preamble detection circuit 212 includes a shift register including four flip-flop circuits F1 through F4 which are connected in series as illustrated in FIG. 11. The preamble detection circuit 212 further includes another shift register including four flip-flop circuits F11 through F14 which are connected in series as illustrated in FIG. 11. The preamble detection circuit 212 further includes an AND circuit A and five EX (Exclusive)-NOR circuits N1 through N5. As illustrated in FIG. 11, the five EX-NOR circuits N1 through N5 are arranged in a manner that the outputs of the five EX-NOR circuits N1 through N5 are input in parallel to the respective five input terminals of the AND circuit A. The five EX-NOR circuits N1 through N5 calculate exclusive NOR values.

One (the first) input of the EX-NOR circuit N1 is connected to the output of the flip-flop circuit F1. One input of the EX-NOR circuit N2 is connected to the output of the flip-flop circuit F2. One input of the EX-NOR circuit N3 is connected to the output of the flip-flop circuit F3. One input of the EX-NOR circuit N4 is connected to the output of the flip-flop circuit F4. One input of the EX-NOR circuit N5 is connected to the input of the flip-flop circuit F4.

Further, the other (the second) input of the EX-NOR circuit N1 is connected to the output of the flip-flop circuit F11. The other input of the EX-NOR circuit N2 is connected to the output of the flip-flop circuit F12. The other input of the EX-NOR circuit N3 is connected to the output of the flip-flop circuit F13. The other input of the EX-NOR circuit N4 is connected to the output of the flip-flop circuit F14. The other input of the EX-NOR circuit N5 is connected to the input of the flip-flop circuit F14.

In the example circuit of FIG. 11, in each of the five EX-NOR circuits N1 through N5, when an input value of the first input terminal corresponds (is equal) to an input value of the second input terminal, all of the five EX-NOR circuits N1 through N5 outputs a high level (“1”). Then, the AND circuit A outputs the high level (“1”). As a result, the preamble detection report signal N_{PX} is output from the AND circuit A to the reception control circuit 204.

Herein, the received data D_{RX} is input to the flip-flop circuit F4 via the FIFO 215. On the other hand, the phase adjustment pattern P_{X} corresponding to lanes is input to the flip-flop circuit F14. The phase adjustment pattern P_{X} is supplied from the serial-to-parallel conversion circuit 203. When the preamble pattern PA which is a header part of the phase adjustment pattern is generated in step S42 of FIG. 10, the preamble pattern PA is input to the flip-flop circuit F14. After that, the bit data of the preamble pattern PA are sequentially shifted bit by bit in the shift register including the four flip-flop circuits F11 through F14 connected in series. Then, in a state where the generation of the phase adjustment patterns is stopped in step S43, five bits included in the preamble pattern PA are present at the inputs and outputs of the flip-flop circuits F14 through F11. More specifically, the five bits data included in the preamble pattern PA are present at the input of the F14, the output of F14, the output of F13, the output of F12, and the output of F11, respectively. In the example of the preamble pattern PA of the phase adjustment pattern P₀, the input of the F14, the output of F14, the output of F13, the output of F12, and the output of F11 represent 0, 1, 1, 1, and 0, respectively. As a result, the five bits data of the preamble pattern PA are supplied to the second inputs of the five EX-NOR circuits N1 through N5, respectively. This status is maintained during a period from when the generation of the phase adjustment patterns is stopped in step S43 to when the preamble pattern is detected and the generation of the phase adjustment patterns is resumed in step S45.

In the same manner, the received data D_{RX} input to the flip-flop circuit F4 is also sequentially shifted bit by bit in the shift register including the four flip-flop circuits F4 through F1 connected in series. As a result, the bit data of the received data D_{RX} are present at the output of F1, the output of F2, the output of F3, the output of F4, and the input of the F4, respectively. As the received data D_{RX} are sequentially input in the shift register bit by bit via the FIFO 215, the bit data of the received data D_{RX} are also sequentially shifted in the shift register. As a result, the bit data at the output of F1, the output of F2, the output of F3, the output of F4, and the input of the F4 are sequentially updated. The bit data of the received data D_{RX} present at the output of F1, the output of F2, the output of F3, the output of F4, and the input of the F4 are applied to the first inputs of the EX-NOR circuit N1 through N5, respectively. In the same manner, the bit data of the preamble pattern PA present at the output of F11, the output of F12, the output of F13, the output of F14, and the input of the F14 are applied to the second inputs of the EX-NOR circuit N1 through N5, respectively. Therefore, when the bit data of the received data D_{RX} correspond to the bit data of the preamble pattern PA in each of the bits, all of the five EX-NOR circuits N1 through N5 output a high level (“1”). Then, as described above, the AND circuit A outputs the high level (“1”). As a result, the preamble detection report signal N_{PX} is output to the reception control circuit 204.

Further, the example circuit of FIG. 11 may also be used as an example circuit of the pattern comparison circuits 213. In the case of the pattern comparison circuits 213, similar to the case of the preamble detection circuit 212, as the bit data of the received data D_{RX} are sequentially input, the bit data of the output of F1, the output of F2, the output of F3, the output of F4, and the input of F4 are also sequentially updated. In this case, the state where the pattern comparison circuits 213 operates refers to the state where the preamble pattern PA is detected in step S45 of FIG. 10 and the generation of the phase adjustment patterns is resumed in the receiving side circuit 200. Therefore, unlike the case of the preamble detection circuit 212, as the bit data of the phase adjustment pattern P_{X} are sequentially input from the serial-to-parallel conversion circuit 203, the adjustment pattern P_{X} as the bit data of the output of F11, the output of F12, the output of F13, the output of F14, and the input of F14 are also sequentially updated.

Therefore, when the bit data of the received data D_{RX} correspond to the bit data of the adjustment pattern P_{X}, all of the five EX-NOR circuits N1 through N5 output a high level (“1”). Then, the AND circuit A outputs the high level (“1”). As a result, the pattern correspondence report signal N_{CX} is output to the reception control circuit 204. In the case of the pattern comparison circuits 213, unlike the case of the preamble detection circuit 212 that determines the correspondence between the preamble patterns PA, the correspondence between the phase adjustment patterns of the respective lanes is determined. The correspondence between the phase adjustment patterns of the respective lanes refers to the fact that one cycle of one phase adjustment pattern corresponds to one cycle of another phase adjustment pattern. In the example of FIG. 6, the number of bits of one cycle of the phase adjustment patterns of the respective lanes is 31 (bits). Therefore, in the example of FIG. 16, when the example circuit of FIG. 11 is used as the pattern comparison circuits 213, the reception control circuit 204 may perform determination described below. Namely, the reception control circuit 204 may determine the correspondence of the phase adjustment pattern of the lane when the pattern correspondence report signals N_{CX} corresponding to the consecutive 31 bits of data are received from the pattern comparison circuit 213 of the receiving circuit.

Next, an example circuit generating the M-sequence applicable as the fundamental phase adjustment pattern P_{B} is described with reference to FIG. 12. The example circuit may be used as the phase adjustment pattern generation circuit 101 of the transmission side circuit 100 and the phase adjustment pattern generation circuit 201 of the receiving side circuit 200. As illustrated in FIG. 12, the example circuit includes a shift register including four flip-flop circuits D1 through D4 which are connected in series with each other. In this example circuit, the output value of the third flip-flop circuit D3 and the output value of the fourth flip-flop circuit D4 are fed-back to the input of the first flip-flop circuit D1 via the EX-OR circuit EXOR1. Therefore, when the output value of the third flip-flop circuit D3 corresponds to the output value of the fourth flip-flop circuit D4, a value “0” is fed-back to the input of D1. On the other hand, when the output value of the third flip-flop circuit D3 does not correspond to the output value of the fourth flip-flop circuit D4, a value “1” is fed-back to the input of D1.

In the example circuit of FIG. 12, for example, when it is assumed that values “0, 0, 0, 1” are set as the output values of D4, D3, D2, and D1, respectively, an M-sequence “000100110101111” having a cycle of 15 bits is generated. Generally, when shift registers having N stages are used, an M-sequence having a cycle of 2^{N}−1 bits is generated. In the example of FIG. 12, a shift register having four stages by using the four flip-flop circuits D1 through D4 is used. Therefore, the number of bits of the M-sequence is 15 (i.e., 2⁴−1=16−1=15). Therefore, in this example, the M-sequence having a cycle of 15 bits as described above is generated. In the example of FIG. 6, the number of bits of the cycle of the fundamental phase adjustment pattern P_{B} is 31. Therefore, this fundamental phase adjustment pattern P_{B} is obtained by using a shift register having five stages (of flip-flop circuits) (i.e., 2⁵−1=31).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it is to be understood that various changes, substitutions, and alterations could be made hereto without departing from the spirit and scope of the invention.

What is claimed is:

1. A method for adjusting a phase for transmission circuits and receiving circuits connected to one of the transmission circuits, the method comprising:
generating phase adjustment patterns each of which corresponding to one of the transmission circuits by performing a serial-to-parallel conversion on a fundamental phase adjustment pattern in a transmission side circuit;
transmitting, by the transmission circuits, transmission signals each including the phase adjustment pattern;
generating phase adjustment patterns each of which corresponding to one of the receiving circuits corresponding to one of the transmission circuits by performing the serial-to-parallel conversion on the fundamental phase adjustment pattern in a receiving side circuit;
receiving, by the receiving circuits, the transmission signal sent from corresponding transmission circuit using a reception clock signal;
comparing signal patterns included in the received transmission signal with the phase adjustment patterns; and
adjusting a phase of the reception clock signal based on results of the comparing.

2. The method according to claim 1, further comprising:
determining number of bits included in the fundamental phase adjustment pattern and a cycle of the fundamental phase adjustment pattern, the number of bits of the predetermined cycle of the fundamental phase adjustment pattern being determined in a manner that the number of bits of the cycle of the fundamental phase adjustment pattern and the number of the transmission circuits are relatively prime to each other.

3. A data transmission device comprising:
transmission circuits, each of the transmission circuits transmits a transmission signal; and
a phase adjustment pattern generation unit that generates phase adjustment patterns each of which corresponding to one of the transmission circuits by performing a serial-to-parallel conversion on a fundamental phase adjustment pattern; wherein
each of the transmission circuits transmits transmission signals that includes the corresponding phase adjustment patterns generated.

4. The data transmission device according to claim 3,
wherein the phase adjustment pattern generation unit is configured to generate the phase adjustment patterns from the fundamental phase adjustment pattern including bits and having a predetermined cycle, and
the phase adjustment pattern generation unit is configured to determine the number of bits of the predetermined cycle of the fundamental phase adjustment pattern in a manner that the number of bits of the cycle of the fundamental phase adjustment pattern and the number of the transmission circuits are relatively prime to each other.

5. The data transmission device according to claim 4,
wherein the phase adjustment pattern generation unit is configured to generate the phase adjustment patterns in a manner that all of the phase adjustment patterns do not present a same theoretical value at a same time by allocating bits of the fundamental phase adjustment pattern among the transmission circuits in accordance with a predetermined order by performing the serial-to-parallel conversion.

6. A data transmission device comprising:
receiving units each of which receiving transmission signal from the other transmission device using a reception clock;
a phase adjustment pattern generation unit that generates phase adjustment patterns each of which corresponding to one of the receiving circuits by performing a serial-to-parallel conversion on a fundamental phase adjustment pattern;
a comparison circuit that compares signal patterns included in the received transmission signal with the generated phase adjustment patterns; and
a phase adjustment circuit that adjusts a phase of the reception clock signal based on the comparison results by the comparison circuit.

7. The data transmission device according to claim 6,
wherein the phase adjustment pattern generation unit is configured to generate the phase adjustment patterns from the fundamental phase adjustment pattern including bits and having a predetermined cycle, and
the phase adjustment pattern generation unit is configured to determine the number of bits of the predetermined cycle of the fundamental phase adjustment pattern in a manner that the number of bits of the cycle of the fundamental phase adjustment pattern and the number of the receiving circuits are relatively prime to each other.

8. The data transmission device according to claim 7,
wherein the phase adjustment pattern generation unit is configured to generate the phase adjustment patterns in a manner that all of the phase adjustment patterns do not present a same theoretical value at a same time by allocating bits of the fundamental phase adjustment pattern among the receiving circuits in accordance with a predetermined order by performing the serial-to-parallel conversion.

9. The data transmission device according to claim 8,
wherein the phase adjustment pattern generation unit is configured to stop generating the phase adjustment patterns when preamble parts of the phase adjustment patterns are generated, and resume the generating of the phase adjustment patterns when the preamble parts of the phase adjustment patterns are detected in the transmission signals.

10. A data transmission system comprising:
a transmission side circuit; and
a receiving side circuit;
wherein the transmission side circuit includes:
a first phase adjustment pattern generation unit configured to generate phase adjustment patterns corresponding to transmission circuits by performing a serial-to-parallel conversion on a fundamental phase adjustment pattern; and
a transmission circuit configured to transmit transmission signals including the phase adjustment patterns, the transmission circuit including the transmission circuits, and
wherein the receiving side circuit includes:
a second phase adjustment pattern generation unit configured to generate phase adjustment patterns corresponding to receiving circuits by performing the serial-to-parallel conversion on the fundamental phase adjustment pattern;
a receiving circuit configured to receive the transmission signals using a reception clock signal, the receiving circuit including the receiving circuits;
a comparison circuit configured to compare signal patterns included in the transmission signals with the phase adjustment patterns and output comparison results; and
a phase adjustment circuit configured to adjust a phase of the reception clock signal based on the comparison results.

11. The data transmission system according to claim 10,
wherein the first phase adjustment pattern generation unit is configured to generate phase adjustment patterns from the fundamental phase adjustment pattern including bits and having a predetermined cycle, and
wherein the first phase adjustment pattern generation unit is configured to determine the number of bits of the predetermined cycle of the fundamental phase adjustment pattern in a manner that the number of bits of the cycle of the fundamental phase adjustment pattern and the number of the transmission circuits are relatively prime to each other.

12. The data transmission system according to claim 11,
wherein the first and the second phase adjustment pattern generation units are configured to generate phase adjustment patterns in a manner that all of the phase adjustment patterns do not present a same theoretical value at a same time among the transmission circuits and the receiving circuits by allocating bits of the fundamental phase adjustment pattern among the transmission circuits and the receiving circuits, respectively, in accordance with a predetermined order by performing the serial-to-parallel conversion.

13. The data transmission system according to claim 12,
wherein the first and the second phase adjustment pattern generation units are configured to stop the generation of the phase adjustment patterns when preamble parts of the phase adjustment patterns are generated and resume the generation of the phase adjustment patterns when the preamble parts of the phase adjustment patterns are detected in the transmission signals.
